(19) United States
(12) Patent Application Publication
(10) Pub. No.: US 2026/0005249 A1
(43) Pub. Date: Jan. 1, 2026

(54) NON-AQUEOUS ELECTROLYTE SECONDARY-BATTERY POSITIVE ELECTRODE, NON-AQUEOUS ELECTROLYTE SECONDARY BATTERY USING THE SAME, BATTERY MODULE, AND BATTERY SYSTEM

(71) Applicant: SEKISUI CHEMICAL CO., LTD., Osaka (JP)

(72) Inventors: Taro MOMOZAKI, Tsukuba-shi (JP); Yuichi SABI, Tsukuba-shi (JP)

(73) Assignee: SEKISUI CHEMICAL CO., LTD., Osaka (JP)

(21) Appl. No.: 19/102,537

(22) PCT Filed: Sep. 1, 2023
(86) PCT No.: PCT/JP2023/032114

§ 371 Date: Feb. 10, 2025

(30) Foreign Application Priority Data
Sep. 2, 2022 (JP) 2022-140246

(51) Int. Cl. H01M 4/62; H01M 4/02; H01M 10/0525; H01M 10/0568

(52) U.S. Cl. CPC H01M 4/622; H01M 4/625; H01M 10/0525; H01M 10/0568; H01M 2004/021; H01M 2004/028

(57) ABSTRACT

A positive electrode for a non-aqueous electrolyte secondary battery, including a positive electrode current collector and a positive electrode active material layer provided on the positive electrode current collector, wherein: the positive electrode active material layer includes positive electrode active material particles with at least part of their surfaces being coated with a conductive material; the positive electrode current collector includes a positive electrode current collector main body and a current collector coating layer present on a surface of the positive electrode current collector main body on a side of the positive electrode active material layer; and the positive electrode active material layer includes a particulate binder.

### TECHNICAL FIELD

The present invention relates to a positive electrode for non-aqueous electrolyte secondary battery, as well as a non-aqueous electrolyte secondary battery, a battery module, and a battery system, each using the positive electrode.

Priority is claimed on Japanese Patent Application No. 2022-140246, filed Sep. 2, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter also referred to as “separator”) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a metal foil as a current collector.

Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate (LiFePO₄).

A positive electrode has a positive electrode current collector and a positive electrode active material layer provided on the positive electrode current collector. To form a positive electrode active material layer on a positive electrode current collector, a positive electrode composition containing positive electrode active material particles, a binder, and a solvent is applied onto the positive electrode current collector, and then dried to remove the solvent.

To improve battery performance, it is necessary to obtain a positive electrode composition with excellent dispersibility of positive electrode active material particles. Conventionally, a positive electrode composition with excellent dispersibility of positive electrode active material particles has been known that contains at least one of an electrode active material or a carbon material as a conducting agent, an anionic dispersant, and water, in which the anionic dispersant has at least one of a carboxylic acid or a sulfonic acid as an anionic site, an acid value of 100 to 600 mgKOH/g, a hydroxyl value of 0 to 400 mgKOH/g, and a weight average molecular weight of 5,000 or more (see, for example, Patent Document 1).

### CITATION LIST

### Patent Document

Patent Document 1: Japanese Patent Granted Publication No. 5252134

### SUMMARY OF INVENTION

### Technical Problem

However, there is a problem that the positive electrode produced using the positive electrode composition of Patent Document 1 has a high resistance, and a non-aqueous electrolyte secondary battery having this positive electrode shows a poor post-storage low-temperature output and a low energy density.

The present invention has been made in consideration of the above circumstances, and an object of the present invention is to provide a positive electrode for a non-aqueous electrolyte secondary battery, which enables production of a non-aqueous electrolyte secondary battery with high post-storage low-temperature output and high energy density, as well as a non-aqueous electrolyte secondary battery, a battery module, and a battery system, each using the same.

### Solution to Problem

The embodiments of the present invention are as follows.

[1] A positive electrode for a non-aqueous electrolyte secondary battery, comprising a positive electrode current collector and a positive electrode active material layer provided on the positive electrode current collector, wherein:
the positive electrode active material layer comprises positive electrode active material particles with at least part of their surfaces being coated with a conductive material;
the positive electrode current collector comprises a positive electrode current collector main body and a current collector coating layer present on a surface of the positive electrode current collector main body on a side of the positive electrode active material layer; and
the positive electrode active material layer comprises a particulate binder.

[2] The positive electrode according to [1], wherein the positive electrode active material particles are present in an amount of 93% by mass or more, relative to a total mass of the positive electrode active material layer.

[3] The positive electrode according to [1] or [2], wherein the particulate binder is present in an amount of 4% by mass or less, relative to a total mass of the positive electrode active material layer.

[3-1] The positive electrode according to [1] or [2], wherein an amount of the particulate binder is less than 3.8% by mass, relative to a total mass of the positive electrode active material layer.

[3-2] The positive electrode according to [1] or [2], wherein an amount of the particulate binder is 3% by mass or less, relative to a total mass of the positive electrode active material layer.

[3-3] The positive electrode according to [1] or [2], wherein an amount of the particulate binder is 2% by mass or less or less than 2% by mass, relative to a total mass of the positive electrode active material layer.

[3-4] The positive electrode according to [1] or [2], wherein an amount of the particulate binder is 1.5% by mass or less, relative to a total mass of the positive electrode active material layer.

[4] The positive electrode according to any one of [1] to [3-4], wherein the positive electrode active material layer contains a conducting agent, and an amount of the conducting agent is 5% by mass or less, relative to a total mass of the positive electrode active material layer.

[4-1] The positive electrode according to any one of [1] to [3-4], wherein the positive electrode active material layer comprises a conducting agent, and an amount of the conducting agent is less than 1.8% by mass, relative to a total mass of the positive electrode active material layer.

[4-2] The positive electrode according to any one of [1] to [3-4], wherein the positive electrode active material layer comprises a conducting agent, and an amount of the conducting agent is 1.0% by mass or less, relative to a total mass of the positive electrode active material layer.

[4-3] The positive electrode according to any one of [1] to [3-4], wherein the positive electrode active material layer comprises a conducting agent, and an amount of the conducting agent is 0.5% by mass or less, relative to a total mass of the positive electrode active material layer.

[5] The positive electrode according to any one of [1] to [4-3], wherein the particulate binder has an average particle diameter of 50 nm or more.

[5-1] The positive electrode according to any one of [1] to [5], wherein the particulate binder has an average particle diameter of less than 500 nm.

[5-2] The positive electrode according to any one of [1] to [5], wherein the particulate binder has an average particle diameter of 400 nm or less.

[5-3] The positive electrode according to any one of [1] to [5], wherein the particulate binder has an average particle diameter of 350 nm or less.

[5-4] The positive electrode according to any one of [1] to [5], wherein the particulate binder has an average particle diameter of 300 nm or less.

[6] A non-aqueous electrolyte secondary battery, comprising the positive electrode of any one of [1] to [5-4], a negative electrode, and a non-aqueous electrolyte disposed between the positive electrode and the negative electrode.

[7] The nonaqueous electrolyte secondary battery of [6], wherein the non-aqueous electrolyte contains a lithium imide salt represented by formula (1):

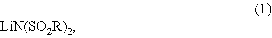

wherein R represents a fluorine atom or Cx₁₍₂ₓ₊₁₎, and x is an integer from 1 to 3.

[8] A battery module or battery system including a plurality of the non-aqueous electrolyte secondary batteries of [7].

### Advantageous Effects of Invention

The present invention can provide a positive electrode for a non-aqueous electrolyte secondary battery, which enables production of a non-aqueous electrolyte secondary battery with a high post-storage low-temperature output and a high energy density, as well as a non-aqueous electrolyte secondary battery, a battery module, and a battery system, each using the same.

### BRIEF DESCRIPTION OF DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

FIG. 3 is a diagram explaining the second measurement method for evaluating whether the binder is in a particulate state, and is a scanning electron microscope image showing a cross section of the positive electrode active material in the positive electrode active material layer.

### DESCRIPTION OF EMBODIMENTS

In the present specification and claims, “to” indicating a numerical range means that the numerical values described before and after “to” are included as the lower limit and the upper limit of the range.

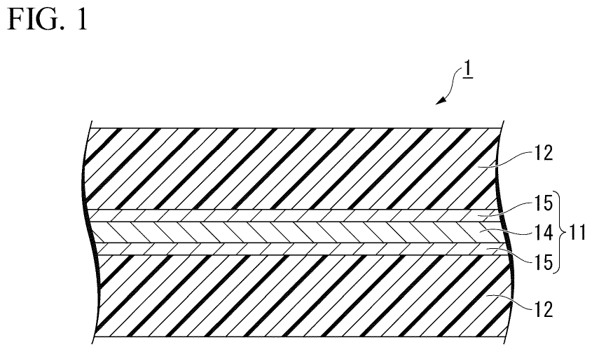

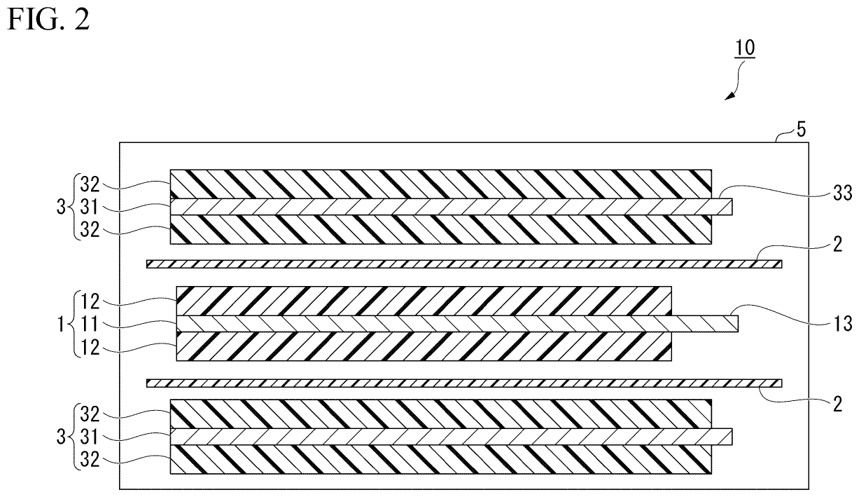

FIG. 1 is a schematic cross-sectional view showing one embodiment of the positive electrode of the present invention for a non-aqueous electrolyte secondary battery, and FIG. 2 is a schematic cross-sectional view showing one embodiment of the non-aqueous electrolyte secondary battery of the present invention.

FIG. 1 and FIG. 2 are schematic diagrams for facilitating the understanding of the configurations, and the dimensional ratios and the like of each component do not necessarily represent the actual ones.

### <Positive Electrode for Non-Aqueous Electrolyte Secondary Battery>

In the present embodiment, the positive electrode for a non-aqueous electrolyte secondary battery (also simply referred to as “positive electrode”) 1 has a positive electrode current collector 11 and a positive electrode active material layer 12.

The positive electrode active material layer 12 is present on at least one surface of the positive electrode current collector 11. The positive electrode active material layers 12 may be present on both sides of the positive electrode current collector 11.

In the example shown in FIG. 1, the positive electrode current collector 11 has a positive electrode current collector main body 14 and current collector coating layers 15 that cover the positive electrode current collector main body 14 on a part of its surfaces facing the positive electrode active material layers 12.

### [Positive Electrode Active Material Layer]

The positive electrode active material layer 12 includes positive electrode active material particles.

The positive electrode active material layer 12 further includes a particulate binder. It is assumed that the particulate binder is crushed in the positive electrode active material layer 12 and adheres to the surface of the positive electrode active material.

The positive electrode active material layer 12 may further include a conducting agent.

The positive electrode active material particles include a positive electrode active material. The positive electrode active material particles have a core section composed of only the positive electrode active material, and a coating section (active material coating section) covering the core section, which are hereinafter also referred to as “coated particles”. The positive electrode active material particles contained in the positive electrode active material layer 12 are coated particles.

The positive electrode active material preferably contains a compound having an olivine crystal structure.

The compound having an olivine crystal structure is preferably a compound represented by the following formula: LiFeₓM₍₁₋ₓ₎PO₄ (hereinafter, also referred to as “formula (1)”). In the formula (1), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (1) does not impair the effect of the present invention.

The compound represented by the formula (1) is preferably lithium iron phosphate represented by LiFePO₄ (hereinafter, also referred to as “lithium iron phosphate”).

The positive electrode active material may contain other positive electrode active materials than the compound having an olivine type crystal structure.

Preferable examples of the other positive electrode active materials include a lithium transition metal composite oxide. Specific examples thereof include lithium cobalt oxide, lithium nickel oxide, lithium nickel cobalt aluminum oxide (LiNiₓCo_{y}Al_{z}O₂ with the proviso that x+y+z=1), lithium nickel cobalt manganese oxide (LiNiₓCo_{y}Mn_{z}O₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide (LiCoVO₄), as well as nonstoichiometric compounds formed by partially substituting the compounds listed above with metal elements. Examples of the metal element include one or more selected from the group consisting of Mn, Mg, Ni, Co, Cu, Zn and Ge.

With respect to the other positive electrode active materials, a single type thereof may be used individually or two or more types thereof may be used in combination.

The other positive electrode active material may have, on at least a part of its surface, the coated section described above.

The amount of the compound having an olivine type crystal structure is preferably 50% by mass or more, preferably 80% by mass or more, and even more preferably 90% by mass or more, based on the total mass of the positive electrode active material. The amount of the compound having an olivine type crystal structure may be 100% by mass, based on the total mass of the positive electrode active material particles.

When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material. This amount may be 100% by mass.

The positive electrode active material particles in the present embodiment are in the form of coated particles in which at least a part of the surface of the positive electrode active material particles is coated with a conductive material. The use of the coated particles as the positive electrode active material particles enables the battery capacity and high-rate cycling performance to be further enhanced.

The conductive material of the active material coating section preferably contains carbon. The conductive material may be composed only of carbon, or may be a conductive organic compound containing carbon and other elements other than carbon. Examples of the other elements include nitrogen, hydrogen, oxygen and the like. In the conductive organic compound, the amount of the other elements is preferably 10 atomic % or less, and more preferably 5 atomic % or less.

It is more preferable that the conductive material in the active material coating section is composed only of carbon.

The amount of the conductive material is 0.1 to 3.0% by mass, more preferably 0.5 to 1.5% by mass, even more preferably 0.7 to 1.3% by mass, based on the total mass of the positive electrode active material including the active material coating section.

The coated particles are preferably coated particles having a compound with an olivine crystal structure as the core section, more preferably coated particles having a compound represented by the formula (1) as the core section, and even more preferably coated particles having lithium iron phosphate as the core section (hereinbelow, also referred to as “coated lithium iron phosphate particles”). These coated particles can further enhance the battery capacity and the cycling performance.

In addition, it is particularly preferable that the entire surface of the core section of the coated particles is coated with a conductive material.

The coated particles can be produced by a known method. A method for producing the coated particles is described below by taking the coated lithium iron phosphate particles as an example.

Examples of the method include a method in which a graphitizable resin or a non-graphitizable resin, naphthalene, coal tar, binder pitch, etc. is added as a precursor to the lithium iron phosphate particles and the resulting is heat-treated at 600 to 1300° C., and a method in which fluidized lithium iron phosphate particles are subjected to chemical vapor deposition (CVD) by heat treatment at 600 to 1300° C. using hydrocarbon compounds such as methanol, ethanol, benzene, and toluene as a chemical vapor deposition carbon source, to thereby form a carbon coating on the surface.

The amount of carbon coating the particles of the lithium iron phosphate powder and the resistivity can be adjusted by optimizing the heating time and temperature in the step of implementing heat treatment while supplying methanol vapor. It is desirable to remove the carbon particles not consumed for coating by subsequent steps such as classification and washing.

The other positive electrode active material may have, on at least a part of its surface, the coated section described above.

The thickness of the active material coating section of the positive electrode active material is 1 to 100 nm, preferably 1 to 50 nm, more preferably 1 to 10 nm.

The thickness of the active material coating section of the positive electrode active material can be measured by a method of measuring the thickness of the active material coating section in a transmission electron microscope (TEM) image of the positive electrode active material. The thickness of the active material coating section on the surface of the positive electrode active material need not be uniform. It is preferable that the positive electrode active material has, on at least a part of its surface, the active material coating section having a thickness of 1 nm or more, and the maximum thickness of the active material coating section is 100 nm or less.

For example, the active material coating section is formed in advance on the surface of the positive electrode active material particles, and is present on the surface of the positive electrode active material particles in the positive electrode active material layer. That is, the active material coating section in the present specification is not one newly formed in the steps following the preparation step of a positive electrode composition. In addition, the active material coating section is not one that comes off in the steps following the preparation step of a positive electrode composition.

For example, the active material coating section stays on the surface of the core section of the positive electrode active material particles even when the coated particles are mixed with a solvent by a mixer or the like during the preparation of a positive electrode composition. Further, the active material coating section stays on the surface of the positive electrode active material even when the positive electrode active material layer is detached from the positive electrode and then put into a solvent to dissolve the binder contained in the positive electrode active material layer in the solvent. Furthermore, the active material coating section stays on the surface of the positive electrode active material even when an operation to disintegrate agglomerated particles is implemented for measuring the particle size distribution of the particles in the positive electrode active material layer by the laser diffraction scattering method.

The active material coating section of the active material particles preferably covers 50% or more, preferably 70% or more, and more preferably 90% or more of the total area of the entire outer surfaces of the positive electrode active material particles.

That is, the coated particles have a core section that is a positive electrode active material and an active material coating section that covers the surface of the core section, and the area ratio (coverage) of the active material coating section with respect to the surface area of the core section is preferably 50% or more, more preferably 70% or more, and even more preferably 90% or more.

The coverage can be measured by a method as follows. First, the particles in the positive electrode active material layer are analyzed by the energy dispersive X-ray spectroscopy (TEM-EDX) using a transmission electron microscope. Specifically, an elemental analysis is performed by EDX with respect to the outer peripheral portion of the positive electrode active material particles in a TEM image. The elemental analysis is performed on carbon to identify the carbon covering the positive electrode active material particles. A section with a carbon coating having a thickness of 1 nm or more is defined as a coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

The amount of the positive electrode active material particles is preferably 93% by mass or more, more preferably 95% by mass or more, even more preferably more than 99% by mass, particularly preferably 99.5% by mass or more, based on the total mass of the positive electrode active material layer 12. When the amount of the positive electrode active material particles is not less than the above lower limit, the battery capacity and the cycling performance can be further enhanced.

The average particle size of the positive electrode active material particles (that is, positive electrode active material powder) is, for example, preferably 0.1 to 20.0 μm, more preferably 0.2 to 10.0 μm. When two or more types of positive electrode active materials are used, the average particle size of each of such positive electrode active materials may be within the above range.

The average particle size of the positive electrode active material particles in the present specification is a volume-based median particle size measured using a laser diffraction/scattering particle size distribution analyzer.

The particulate binder contained in the positive electrode active material layer 12 is an organic material, and examples of such materials include acrylic acid ester-acrylic acid copolymers, polyvinyl alcohol-butyraldehyde copolymers, styrene-butadiene copolymers, polyvinylidene fluoride, and vinylidene fluoride-hexafluoropropylene copolymers. With respect to the particulate binder, a single type thereof may be used alone or two or more types thereof may be used in combination.

The average particle diameter of the particulate binder is preferably 50 nm or more, more preferably 160 nm or more, even more preferably 200 nm or more. When the average particle diameter of the particulate binder is not less than the lower limit value described above, it is believed that the resistance decreases and the output performance improves. The upper limit of the average particle diameter of the particulate binder may be 600 nm or less, preferably 500 nm or less, more preferably less than 500 nm, more preferably 400 nm or less, more preferably 350 nm or less, more preferably 300 nm or less, even more preferably 200 nm or less.

The particulate state of the binder can be evaluated, for example, by the following measurement method.

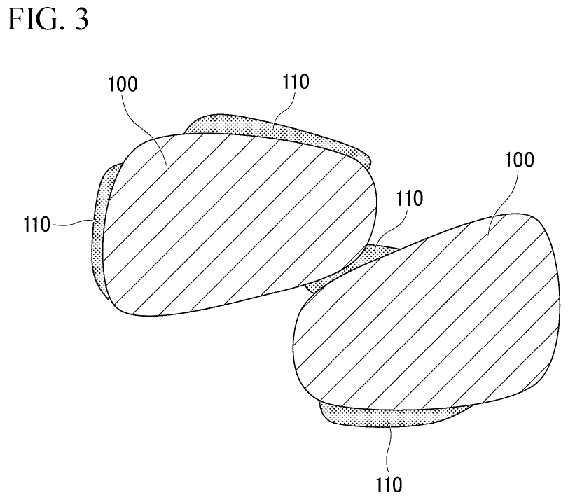

FIG. 3 is a diagram explaining the first measurement method, and shows the state of a cross section of the positive electrode active material in the positive electrode active material layer observed by a scanning electron microscope (SEM). In FIG. 3, reference numeral 100 denotes the positive electrode active material, and reference numeral 110 denotes the particulate binder.

### (First Measurement Method)

As a pretreatment, the positive electrode is cut with an ion milling device to expose the cross section of the positive electrode. The positive electrode is cooled during cutting depending on the heat resistance of the positive electrode active material and the binder.

The cross section of the positive electrode is observed with a scanning electron microscope (SEM), and the carbon component attached to the surface of the positive electrode active material 100 is identified by elemental analysis using energy dispersive X-ray spectroscopy (EDS).

When a particulate binder 110 is used, the carbon component is found to cover significant part of the surface of the positive electrode active material 100 compared to the case where a solution-type binder is used, and the particulate binder 110 is attached. The thickness of the active material coating section is at most 100 nm from the surface of the positive electrode active material, and preferably 10 nm or less, and in the portion where the particulate binder adheres to the surface of the positive electrode active material, the thickness of the particulate binder is 1 μm or more from the surface of the positive electrode active material. Therefore, at the magnification at which the thickness of the particulate binder is determined, the thickness of the active material coating section cannot be determined.

As the microscope, for example, a scanning electron microscope (model name: S4800, manufactured by Hitachi High-Tech Corporation) is used.

### (Second Measurement Method)

As a pretreatment, the positive electrode is cut with a focused ion beam (FIB) device to expose the cross section of the positive electrode.

The cross section of the positive electrode is observed with a transmission electron microscope (TEM), and the carbon component attached to the surface of the positive electrode active material 100 is identified by elemental analysis using energy dispersive X-ray spectroscopy (EDS).

As with the first measurement method, it is confirmed that the binder is in a particulate state.

For the pretreatment, for example, a focused ion beam device (model name: FB2200, manufactured by Hitachi High-Tech Corporation) is used.

As the microscope, for example, a transmission electron microscope (model name: HD2700, manufactured by Hitachi High-Techn Corporation) is used.

### (Third Measurement Method)

As a pretreatment, the positive electrode is cut with an ultramicrotome device to expose a cross section of the positive electrode. The positive electrode is cooled during cutting depending on the heat resistance of the positive electrode active material and the binder.

The cross section of the positive electrode is observed with an atomic force microscope (AFM), and determination is made whether the binder is in a particulate state based on differences in physical properties such as elastic modulus and resistance value. Most of the binder particles (particulate binder) present in the positive electrode active material layer 12 are deformed as shown in FIG. 3 due to adhesion to the surface of the positive electrode active material particles. For the particulate binder 110 in FIG. 3, the particle diameter of the particulate binder can be determined by measuring the diameter of a hypothetical perfect circle having the same cross-sectional area as the particulate binder 110 in FIG. 3. Then, the particle diameters of 10 or more such binder particles are determined to obtain an average particle diameter of the particulate binder.

The amount of the particulate binder in the positive electrode active material layer 12 is preferably 4% by mass or less, more preferably less than 3.8% by mass, more preferably 3% by mass or less, more preferably 2% by mass or less, more preferably less than 2% by mass, more preferably 1.5% by mass or less, even more preferably 1% by mass or less, based on the total mass of the positive electrode active material layer 12. When the amount of the binder is not more than the above upper limit, the proportion of the substance that does not contribute to the conduction of lithium ions in the positive electrode active material layer 12 is reduced, and the true density of the positive electrode active material layer 12 increases. Further, the proportion of the binder covering the surface of the positive electrode 1 is reduced. As a result, the conductivity of lithium is further enhanced, and the high rate cycling performance can be further improved.

The lower limit of the amount of the particulate binder in the positive electrode active material layer 12 is preferably 0.1% by mass or more, based on the total mass of the positive electrode active material layer 12.

Examples of the conducting agent contained in the positive electrode active material layer 12 include carbon materials such as graphite, graphene, hard carbon, Ketjen black, acetylene black, and carbon nanotube. With respect to the conducting agent, a single type thereof may be used alone or two or more types thereof may be used in combination.

The amount of the conducting agent in the positive electrode active material layer 12 is preferably 10% by mass or less, more preferably 5% by mass or less, even more preferably 3% by mass or less, even more preferably less than 1.8 by mass, even more preferably 1.0% by mass or less, even more preferably 0.5% by mass or less, particularly preferably 0.2% by mass or less, most preferably 0% by mass (i.e., the conducting agent is not contained). When the amount of the conducting agent is not more than the above upper limit, the proportion of the substance that does not contribute to the conduction of lithium ions in the positive electrode active material layer 12 is reduced, and the true density of the positive electrode active material layer 12 increases. As a result, the high-rate cycling performance can be further improved.

When the conducting agent is incorporated into the positive electrode active material layer 12, the lower limit value of the amount of the conducting agent is appropriately determined according to the type of the conducting agent, and is, for example, more than 0.1% by mass, based on the total mass of the positive electrode active material layer.

In the context of the present specification, the expression “the positive electrode active material layer 12 does not contain a conducting agent” or similar expression means that the positive electrode active material layer 12 does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer, then, it is judged that substantially no conducting agent is contained.

Conducting agent particles that do not contribute to the creation of conductive path may become a site where self-discharge of the battery starts or a cause of undesirable side reactions.

The positive electrode active material layer 12 may contain additives as necessary. The positive electrode active material layer 12 may contain, for example, carboxymethyl cellulose (CMC) or the like as a viscosity adjuster for the slurry.

### [Positive Electrode Current Collector Main Body]

Examples of the material of the positive electrode current collector main body 14 include conductive metals such as copper, aluminum, titanium, nickel, and stainless steel.

The thickness of the current collector main body 14 is preferably, for example, 8 μm to 40 μm, and more preferably 10 μm to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

The current collector coating layer 15 contains a conductive material.

The conductive material in the current collector coating layer 15 preferably contains carbon (conductive carbon), and more preferably consists exclusively of carbon. The current collector coating layer 15 is preferred to be, for example, a coating layer containing carbon particles such as carbon black and a binder. The binder that can be contained in the current collector coating layer 15 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

With regard to the production of the positive electrode current collector 11 in which the surface of the positive electrode current collector main body 14 is coated with the current collector coating layer 15, for example, the production can be implemented by a method in which a composition (i.e., composition for preparing the current collector coating layer) containing the conductive material, the binder, and a solvent is applied to the surface of the positive electrode current collector main body 14 with a known coating method, followed by drying to remove the solvent.

For controlling the area coverage by the current collector coating layer 15 on the surface of the positive electrode current collector main body 14 on the side of the positive electrode active material layer 12 to fall within the range described below, a coating method such as a spray method or an interval coating method can be used. In the spraying method, the above slurry is sprayed unevenly on the surface of the positive electrode current collector main body 14 on the side of the positive electrode active material layer 12 to achieve a predetermined area coverage. In the spray method, the area coverage can be controlled by adjusting the spray amount, the droplet diameter, and the like. In the interval coating, for example, a mask having slits (through which the slurry passes) provided with intervals is placed on the surface of the positive electrode current collector main body 14 on the side of the positive electrode active material layer 12 to apply the slurry. In the interval coating, the area coverage can be controlled by adjusting the slit intervals and the like.

The thickness of the current collector coating layer 15 is preferably 0.1 to 4.0 μm, more preferably 0.2 to 2.0 μm, and even more preferably 0.5 to 1.2 μm. When the thickness is not lower than the lower limit of the above range, the impedance can be remarkably reduced. When the thickness is not more than the upper limit of the above range, the peel strength can be remarkably improved.

The thickness of the current collector coating layer can be measured by a method that measures the thickness of the coating layer in a transmission electron microscope (TEM) image or a scanning electron microscope (SEM) image of a cross section of the current collector coating layer. The thickness of the current collector coating layer need not be uniform.

When the current collector covering layers 15 are present on both surfaces of the positive electrode current collector main body 14, an average of the thickness values on the both surfaces may be within the above range.

### [Method for Producing Positive Electrode]

The positive electrode 1 of the present embodiment can be produced by a method comprising applying a positive electrode composition containing a positive electrode active material, a particulate binder and a solvent onto a positive electrode current collector 11, followed by drying the positive electrode composition to remove the solvent, thereby forming a positive electrode active material layer 12 on the positive electrode current collector 11.

The active material layer-forming step is performed to press a laminate in which the positive electrode active material layer 12 is formed on the positive electrode collector 11 in a thickness direction against a surface of the positive electrode collector 11 having the current collector coating layer 12, so that a ratio of thickness of the current collector coating layer 15 to thickness of the positive electrode active material layer 12 is adjusted to more than 0.000 and less than 0.020.

The positive electrode composition may contain a conducting agent.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably an aqueous solvent. Examples of the aqueous solvent include water and alcohols such as methanol, ethanol, 1-propanol, and 2-propanol. With respect to these solvents, a single type thereof may be used individually or two or more types thereof may be used in combination.

In the present embodiment, by using the particulate binder, a positive electrode composition can be prepared using an aqueous solvent.

The particulate binder to be used is as described above.

The binder content is 3.2% by mass or less, more preferably 1.6% by mass or less, even more preferably 0.8% by mass or less, based on the total mass of the solid content of the positive electrode composition. When the amount of the binder is not more than the above upper limit, the proportion of the substance that does not contribute to the conduction of lithium ions in the resulting positive electrode active material layer 12 is reduced, and the true density of the positive electrode active material layer 12 increases. Further, the proportion of the binder covering the surface of the positive electrode 1 is reduced. As a result, the conductivity of lithium is further enhanced, and the high rate cycling performance can be further improved.

When preparing the positive electrode composition, the timing for adding the particulate binder to the solvent is preferably immediately before the preparation of the positive electrode composition is completed. That is, when preparing the positive electrode composition, the particulate binder is preferably added last. In general, when preparing the positive electrode composition, the solvent is added to the positive electrode composition while the solid content is high, and the concentration is reduced to a level suitable for application. However, if the binder is added while the solid content is high, the positive electrode composition may aggregate and become unsuitable for application.

The temperature for preparing the positive electrode composition is preferably 5 to 60° C., more preferably 10 to 50° C., even more preferably 15 to 40° C. When the temperature is not less than the lower limit value described above, it is possible to prevent the solvent from being frozen to cause agglomeration of the positive electrode composition, which is expected to facilitate the dispersion of the materials to make the coating surface uniform. When the temperature is not more than the upper limit value described above, the solids concentration increases as the solvent evaporates due to heat generated by the positive electrode composition or the device during preparation, which is expected to prevent the positive electrode composition from agglomerating.

When at least one of the conductive material and the conducting agent covering the positive electrode active material contains carbon, the positive electrode 1 preferably has a conductive carbon content of 0.5 to 4.0% by mass, even more preferably 1.5 to 3.0% by mass, with respect to the mass of the positive electrode 1 excluding the positive electrode current collector main body 14.

When the positive electrode 1 is composed of the positive electrode current collector main body 14, the current collector coating layer 15, and the positive electrode active material layer 12, the mass of the positive electrode 1 excluding the positive electrode current collector main body 14 is the sum of the mass of the current collector coating layer 15 and the mass of the positive electrode active material layer 12.

When the conductive carbon content based the total mass of the positive electrode active material layer 12 is within the above range, the battery capacity can be further improved, and a non-aqueous electrolyte secondary battery with a further improved cycle characteristics can be realized.

The amount of the conductive carbon with respect to the mass of the positive electrode 1 excluding the positive electrode current collector main body 14 can be measured by <<Method for measuring conductive carbon content>> described below with respect to a dried product (powder), as a measurement target, obtained by detaching the whole of a layer present on the positive electrode current collector main body 14, collecting the whole of substance resulting from the detached layer, and vacuum-drying the collected substance at 120° C.

The conductive carbon to be measured by the <<Method for measuring conductive carbon content>> described below includes carbon in the coated section of the positive electrode active material, carbon in the conducting agent, and carbon in the current collector coating layer 15. Carbon in the binder is not included in the conductive carbon to be measured.

As a method for obtaining the measurement target, for example, the following method can be adopted.

First, the layer (powder) present on the positive electrode current collector main body 14 is completely detached by a method in which the positive electrode 1 is punched to obtain a piece having a predetermined size, and the piece of the the positive electrode current collector main body 14 is immersed in a solvent (for example, N-methylpyrrolidone (NMP)) and stirred. Next, after confirming that no powder remains attached to the positive electrode current collector main body 14, the positive electrode current collector main body 14 is taken out from the solvent to obtain a suspension containing the detached powder and the solvent. The obtained suspension is dried at 120° C. to completely volatilize the solvent to obtain the desired measurement target (powder).

### <<Method for Measuring Conductive Carbon Content>>

### [Measurement Method A]

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.

Step A1: A temperature of the sample is raised from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

$$M 2 = ( w 1 - w 3 ) / w 1 \times 100 \qquad ( a2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

[Burning conditions]
Combustion furnace temperature: 1150° C.
Temperature of reduction furnace: 850° C.
Helium flow rate: 200 mL/min.
Oxygen flow rate: 25 to 30 mL/min.

### [Measurement Method C]

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH₂CF₂), molecular weight 64), the conductive carbon content can be calculated by the following formula from the fluoride ion (F₋) content (unit: % by mass) measured by combustion ion chromatography based on the tube combustion method, the atomic weight (19) of fluorine in the monomers constituting PVDF, and the atomic weight (12) of carbon in the PVDF.

$$PVDF content ( unit : \% by mass ) = fluoride ion content ( unit : \% by mass ) \times 63 / 38$$

$$PVDF - derived carbon amount M 4 ( unit : \% by mass ) = fluoride ion content ( unit : \% by mass ) \times 12 / 19$$

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by nuclear magnetic resonance spectroscopy (19F-NMR).

When the binder is identified as being other than PVDF, the carbon amount M4 attributable to the binder can be calculated by determining the amount (unit: % by mass) of the binder from the measured molecular weight, and the carbon content (unit: % by mass).

These methods are described in the following publications:
Toray Research Center, The TRC News No. 117 (September 2013), pp. 34-37, [Searched on Feb. 10, 2021], Internet <https://www.toray-research.co.jp/technical-info/trcnews/pdf/TRC117 (34-37).pdf>
TOSOH Analysis and Research Center Co., Ltd., Technical Report No. T1019 2017 Sep. 20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the coated section of the active material. Other particles that are present isolatedly and have low resistance can be judged to be the conducting agent. In this context, a trace amount of carbon considered to be an impurity and a trace amount of carbon unintentionally removed from the surface of the positive electrode active material during production are not judged to be the conducting agent.

Using any of these methods, it is possible to verify whether or not the conducting agent formed of carbon material is contained in the positive electrode active material layer.

The positive electrode 1 of the present embodiment has a positive electrode current collector 11 and a positive electrode active material layer 12 present on the positive electrode current collector 11. The positive electrode active material layer 12 contains positive electrode active material particles, and at least a portion of the surface of the positive electrode active material particles is coated with a conductive material. The positive electrode current collector 11 has a positive electrode current collector main body 14 and a current collector coating layer 15 that covers a portion of the surface of the positive electrode current collector main body 14 facing the positive electrode active material layer 12. The positive electrode active material layer 12 contains a particulate binder. Due to such configuration, the positive electrode 1 of the present embodiment has a higher post-storage low-temperature output and a higher energy density than conventional positive electrodes.

### <Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte. The non-aqueous electrolyte secondary battery 10 may further include a separator 2. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is an exposed section 13 of the positive electrode current collector, which is free of the positive electrode active material layer 12. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

With regard to the production of the non-aqueous electrolyte secondary battery 10 of the present embodiment, for example, the production can be implemented by a method in which the positive electrode 1 and the negative electrode 3 are alternately interleaved through the separator 2 to produce an electrode layered body, which is then packed into an outer casing such as an aluminum laminate bag, and a non-aqueous electrolyte (not shown) is injected into the outer casing, followed by sealing the outer casing.

FIG. 2 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are stacked so that the negative electrode 3 is located at the outermost layer.

### [Negative Electrode]

The negative electrode active material layer 32 includes a negative electrode active material. The negative electrode active material layer 32 may further includes a binder. The negative electrode active material layer 32 may further include a conducting agent. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials such as graphite, graphene, hard carbon, Ketjen black, acetylene black, and carbon nanotube (CNT). With respect to each of the negative electrode active material and the conducting agent, a single type thereof may be used alone or two or more types thereof may be used in combination.

Examples of the material of the negative electrode current collector 31, the binder and the solvent in the negative electrode composition include those listed above as examples of the material of the positive electrode current collector 11, the binder and the solvent in the positive electrode composition. With respect to each of the binder and the solvent in the negative electrode composition, a single type thereof may be used alone or two or more types thereof may be used in combination.

The sum of the amount of the negative electrode active material and the amount of the conducting agent is preferably 80.0% by mass to 99.9% by mass, more preferably 85.0% by mass to 98.0% by mass, based on the total mass of the negative electrode active material layer 32.

### [Separator]

The separator 2 is disposed between the negative electrode 3 and the positive electrode 1 to prevent a short circuit or the like. The separator 2 may retain a non-aqueous electrolyte described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The separator 2 may contain various plasticizers, antioxidants, and flame retardants.

Examples of the antioxidant include phenolic antioxidants such as hinderedphenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### [Non-Aqueous Electrolyte Solution]

The non-aqueous electrolyte solution fills the space between the positive electrode 1 and the negative electrode 3. For example, any of known non-aqueous electrolyte solutions used in lithium ion secondary batteries, electric double layer capacitors and the like can be used.

The nonaqueous electrolyte used in the manufacture of the nonaqueous electrolyte secondary battery 10 contains an organic solvent, an electrolyte, and an additive.

After manufacture, especially after initial charging, the nonaqueous electrolyte secondary battery 10 contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, γ-butyrolactone, sulfolane, dimethyl sulfoxide, acetonitrile, dimethylformamide, dimethylacetamide, 1,2-dimethoxyethane, 1,2-diethoxyethane, tetrahydrofuran, 2-methyltetrahydrofuran, dioxolane, and methyl acetate, as well as mixtures of two or more of these polar solvents.

The electrolyte is not particularly limited, and examples thereof include lithium-containing salts such as lithium perchlorate, lithium hexafluorophosphate, lithium tetrafluoroborate, lithium hexafluoroarsenate, lithium trifluoroacetate, lithium bis(fluorosulfonyl)imide, and lithium bis(trifluoromethanesulfonyl)imide, or mixtures of two or more of these salts.

The non-aqueous electrolyte preferably contains a lithium imide salt represented by the following formula (1):

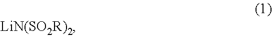

wherein R represents a fluorine atom or CₓF₍₂ₓ₊₁₎, and x is an integer from 1 to 3.

Examples of the lithium imide salt represented by the above formula (1) include lithium bis(fluorosulfonyl)imide (LIFSI), lithium bis(trifluoromethanesulfonyl)imide (LiTFSI), lithium bis(pentafluoroethanesulfonyl)imide (LiBETI), and the like.

The amount of the lithium imide salt in the non-aqueous electrolyte is preferably 5% by mass or more and 90% by mass or less, more preferably 15% by mass or more and 80% by mass or less, even more preferably 30% by mass or more and 75% by mass or less, based on the total mass of the non-aqueous electrolyte. When the amount of the lithium imide salt is not less than the lower limit value described above, the output performance of the non-aqueous electrolyte secondary battery improves. When the amount of the lithium imide salt is not more than the upper limit value described above, the durability of the battery improves.

The non-aqueous electrolyte secondary battery of the present embodiment includes the positive electrode (for a nonaqueous electrolyte secondary battery) of the above-described embodiment, and therefore is excellent in low-temperature output, post-storage low-temperature output, and energy density.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery pack including a plurality of electrically connected battery modules and a battery control system, a battery system including a plurality of electrically connected battery modules and a battery control system, and the like.

### EXAMPLES

Hereinbelow, the present invention will be described with reference to Examples and Comparative Examples; however, the present invention should not be construed as being limited to these Examples.

### <Evaluation Method>

### [Measurement Method for Resistance]

A cell was prepared so as to have a rated capacity of 1 Ah, and the obtained cell was charged at a constant current rate of 0.2 C rate (that is, 200 mA) and with a cut-off voltage of 3.6 V, and then charged at a constant voltage with a cut-off current set at 1/10 of the above-mentioned charge current (that is, 20 mA). The impedance of the cell was then measured at room temperature (25° C.) and a frequency of 1 kHz to obtain a resistance value.

The impedance was measured using the four-terminal method, with a current terminal and a voltage terminal attached to the positive and negative electrode tabs, respectively. As an example, an impedance analyzer manufactured by BioLogic was used to measure the impedance.

The measurement results were evaluated based on the following criteria. The battery with the best performance was categorized as “A”, the battery with the next best performance after A was categorized as “B”, the battery with the next best performance after B was categorized as “C”, and the battery with the poorest performance was categorized as “D”. The following evaluation (measurement) was judged in the same manner.
A: 25 mΩ or less
B: More than 25 mΩ and 30 mΩ or less
C: More than 30 mΩ and 35 mΩ or less
D: More than 35 mΩ

### [Low Temperature Output Evaluation]

The obtained non-aqueous electrolyte secondary battery was fully charged (100% SOC) at 25° C., then discharged at 1C from the fully charged state at −30° C., and the potential was observed 30 seconds after the start of discharge (equivalent to 8 mAh). As a result, the potential of the non-aqueous electrolyte secondary battery was measured.

The measurement results were evaluated based on the following criteria.
A: 2.3 V or more
B: Less than 2.3 V and 1.9 V or more
C: Less than 1.9 V and 1.8 V or more
D: Less than 1.8 V

### [Post-Storage Low Temperature Output Evaluation]

Post-storage low temperature output evaluation was performed according to the following procedure.

The obtained non-aqueous electrolyte secondary battery was fully charged (100% SOC) at 25° C. and then stored in a thermostatic chamber at 70° C. After 20 days, the battery was removed and a low-temperature output evaluation was performed by the method described above.

The degree of voltage maintenance relative to the low-temperature output evaluation (initial low-temperature output evaluation) value described above was calculated.

The calculation results were evaluated based on the following criteria.
A: 90% or more relative to the initial value
B: Less than 90% and 80% or more relative to the initial value
C: Less than 80% and 70% or more relative to the initial value
D: Less than 70%

### [Evaluation of Energy Density]

The evaluation of the energy density was performed according to the following procedures (1) to (3).
(1) A cell was prepared so as to have a rated capacity of 1 Ah, and the mass (unit: kg) of the cell was measured.
(2) In an environment of 25° C., the obtained cell was charged at a constant current rate of 0.2 C rate (that is, 200 mA) and with a cut-off voltage of 3.6 V, and then charged at a constant voltage with a cut-off current set at 1/10 of the above-mentioned charge current (that is, 20 mA). Then, a 30-minute pause was provided while leaving the cell in the open circuit state.
(3) The cell was discharged at a constant current rate of 0.2 C and with a cut-off voltage of 2.5 V. In this process, the gravimetric energy density (unit: Wh/kg) was calculated by dividing the total discharge power (unit: Wh) measured from the start of discharge to the end of discharge by the cell weight (unit: kg) measured in (1).

The calculation results were evaluated based on the following criteria.
A: 175 Wh/kg or more
B: Less than 175 Wh/kg and 165 Wh/kg or more
C: Less than 165 Wh/kg and 150 Wh/kg or more
D: Less than 150 Wh/kg

### [Measurement of the Size of Coarse Particles in the Composition]

The size of coarse particles in the composition during coating was measured. A grind gauge (measurement scale: 0-100 μm) manufactured by BYK was used to measure the size of coarse particles. The composition was cast into the groove of the measuring device, and the smallest scale number at which the composition was not cast due to agglomerates was recorded as the measured value.

### [Electrode Evaluation]

The coated electrode was evaluated.

The coated, dried and pressed electrode was cut into a square piece of 150 mm×150 mm. The electrode weight per unit area after cutting was defined as M1 (mg/cm²). The center of the electrode was then punched out to obtain a square piece having a specified size of 100 mm×100 mm. The electrode weight per unit area after punching was defined as M2.

The peeling rate for punching of the electrode layer was calculated by the following formula (2) and defined as the electrode strength.

$$( Peeling rate ) = 100 - M 2 / M 1 \times 100$$

A lower peeling rate indicates a higher electrode strength. Factors that can cause a decrease in strength may include insufficient dispersion of the active material, insufficient binder required for binding, or even a possibility of the binder not being able to perform its function due to aggregation even if the binder is theoretically sufficient.

The coating performance was evaluated according to the following criteria.
A: Minimum scale number is 60 μm or less, and peeling rate is 5% or less.
B: Minimum scale number is 70 μm or less, or peeling rate is 7% or less.
C: Minimum scale number is 80 μm or less, or peeling rate is 9% or less.
D: Minimum scale number is 90 μm or more, or peeling rate is 10% or more.
   (The “minimum scale number” in this context is the value measured in the above item [Measurement of the size of coarse particles in the composition].)

### Production Example: Production of Negative Electrode

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of a copper foil (thickness 8 μm) and vacuum dried at 100° C. Then, the resulting was pressure-pressed to obtain a negative electrode sheet.

### Example 1

A carbon-coated lithium iron phosphate (hereinbelow, also referred to as “carbon-coated active material”; 99 parts by mass, average particle diameter 1.5 μm, carbon content 1.5% by mass) was used as a positive electrode active material.

A conducting agent was not added to a positive electrode composition.

First, a positive electrode current collector was prepared by coating both the front and back surfaces of a positive electrode current collector main body with current collector coating layers by the following method. An aluminum foil (thickness 15 μm) was used as the positive electrode current collector main body.

A slurry was obtained by mixing 100 parts by mass of carbon black, 40 parts by mass of polyvinylidene fluoride as a binder, and N-methyl-2-pyrrolidone (NMP) as a solvent.

The obtained slurry was applied so as to form a 1 μm-thick coating on both surfaces of the positive electrode current collector main body by a gravure method and dried to remove the solvent, thereby obtaining a positive electrode current collector having current collector coating layers.

Next, a positive electrode active material layer was formed by the following method.

A positive electrode composition was obtained by mixing 99 parts by mass of the carbon-coated active material, 0.5 parts by mass of acrylic particles (particles of an acrylic acid ester-acrylic acid copolymer, average particle size: 300 nm) as a binder, 0.5 parts by mass of carboxymethyl cellulose, and water as a solvent in a mixer. The amount of the solvent used was the amount required for applying the positive electrode composition.

The positive electrode composition was applied on both sides of the positive electrode current collector, and after pre-drying, the applied composition was vacuum-dried at 120° C. to form positive electrode active material layers, each having a thickness of 70 μm.

The resulting laminate was pressure-pressed with a load of 10 kN to obtain a positive electrode sheet.

When the cross section of the obtained positive electrode sheet was observed with an SEM, an image was obtained in which a particulate binder seemed to be attached to the surface of the carbon-coated active material.

A non-aqueous electrolyte secondary battery having a configuration shown in FIG. 2 was manufactured by the following method.

A non-aqueous electrolytic solution was prepared by dissolving LiPF₆ and LIFSI as electrolytes in a mass ratio of 65:35 so as to give a concentration of 1 mol/liter in a solvent prepared by mixing ethylene carbonate (EC), propylene carbonate (PC), and diethyl carbonate (DEC) in a volume ratio EC:PC:DEC of 30:5:65.

The positive electrode obtained in this example and the negative electrode obtained in Production Example 1 were alternately interleaved through a separator to prepare an electrode layered body with its outermost layer being the negative electrode. A polyolefin film (thickness 15 μm) was used as the separator.

In the step of producing the electrode layered body, the separator and the positive electrode were first stacked, and then the negative electrode was stacked on the separator.

Terminal tabs are electrically connected to the exposed section of the positive electrode current collector and the exposed section of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a non-aqueous electrolyte secondary battery (laminate cell).

Table 1 shows the evaluation of the resistance of the positive electrode, the evaluation of the low-temperature output of the non-aqueous electrolyte secondary battery, the evaluation of the post-storage low-temperature output of the non-aqueous electrolyte secondary battery, the evaluation of the volumetric energy density of the non-aqueous electrolyte secondary battery, and the evaluation of the coatability of the positive electrode composition.

### [Observation of the Positive Electrode Active Material Layer]

The positive electrode active material layer was observed using a scanning electron microscope (SEM). The results are shown in FIG. 3. FIG. 3 is an image of a scanning electron microscope showing a cross section of the positive electrode active material in the positive electrode active material layer. As shown in FIG. 3, it can be assumed that the particulate binder 110 has been crushed and adhered to the surface of the positive electrode active material 100.

### Example 2

A positive electrode of Example 2 was produced in the same manner as in Example 1, except that the amount of the carbon-coated active material in the positive electrode composition was changed to 98 parts by mass, and the amount of the acrylic particles was changed to 1.5 parts by mass.

The evaluations described above were performed in the same manner as in Example 1. The results are shown in Table 1.

### Example 3

A positive electrode of Example 3 was produced in the same manner as in Example 1, except that the amount of the carbon-coated active material in the positive electrode composition was changed to 96.2 parts by mass, and the amount of the acrylic particles as a binder was changed to 3.3 parts by mass.

The evaluations described above were performed in the same manner as in Example 1. The results are shown in Table 1.

### Example 4

A positive electrode of Example 4 was prepared in the same manner as in Example 1, except that 0.4 parts by mass of carbon black was added as a conducting agent to the positive electrode composition, relative to 100 parts by mass of the total mass of the carbon-coated active material, the acrylic particles, and the carboxymethyl cellulose.

The evaluations described above were performed in the same manner as in Example 1. The results are shown in Table 1.

### Example 5

A positive electrode of Example 5 was prepared in the same manner as in Example 1, except that 1.8 parts by mass of carbon black was added as a conducting agent to the positive electrode composition, relative to 100 parts by mass of the total mass of the carbon-coated active material, the acrylic particles, and the carboxymethyl cellulose.

The evaluations described above were performed in the same manner as in Example 1. The results are shown in Table 2.

### Example 6

A positive electrode of Example 6 was produced in the same manner as in Example 1, except that the average particle diameter of the acrylic particles was 150 nm.

The evaluations described above were performed in the same manner as in Example 1. The results are shown in Table 2.

### Example 7

A positive electrode of Example 7 was produced in the same manner as in Example 1, except that the average particle diameter of the acrylic particles was 500 nm.

The evaluations described above were performed in the same manner as in Example 1. The results are shown in Table 2.

### Comparative Example 1

A positive electrode of Comparative Example 1 was produced in the same manner as in Example 1, except that the positive electrode composition was prepared using 1 part by mass of carboxymethyl cellulose as a binder.

When the cross section of the obtained positive electrode sheet was observed under SEM, no images were obtained that indicated that particulate binder was attached to the surface of the active material.

The evaluations described above were performed in the same manner as in Example 1. The results are shown in Table 3.

### Comparative Example 2

A positive electrode of Comparative Example 2 was prepared in the same manner as in Example 1, except that a positive electrode current collector was used that did not have a current collector coating layer and was made only of aluminum foil (thickness 15 μm).

The evaluations described above were performed in the same manner as in Example 1. The results are shown in Table 3.

TABLE 1

| | | | Ex. 1 | Ex. 2 | Ex. 3 | Ex. 4 |
|---|---|---|---|---|---|---|
| Positive | Active material | Type | Carbon- | Carbon- | Carbon- | Carbon- |
| electrode | | | coated | coated | coated | coated |
| active | | | active | active | active | active |
| material | | | material | material | material | material |
| | Active material | Parts by mass | 99 | 98 | 96.2 | 99 |
| | Particle diameter | μm | 1.5 | 1.5 | 1.5 | 1.5 |
| | Carbon content of | % by mass | 1.5 | 1.5 | 1.5 | 1.5 |
| | carbon-coated | | | | | |
| | active material | | | | | |
| Conducting agent | | Type | — | — | — | Carbon |
| | | | | | | black |
| | | Parts by mass | 0 | 0 | 0 | 0.4 |
| Binder | Type1 | Type1 | Acrylic | Acrylic | Acrylic | Acrylic |
| | | | particles | particles | particles | particles |
| | Particle diameter | nm | 300 nm | 300 nm | 300 nm | 300 nm |
| | Parts by mass | Parts by mass | 0.5 | 1.5 | 3.3 | 0.5 |
| | Type2 | Type2 | CMG | CMG | CMG | CMG |
| Positive | Carbon coat | Presence or absence | Present | Present | Present | Present |
| electrode | Foil | Type | Aluminum | Aluminum | Aluminum | Aluminum |
| foil | | | foil | foil | foil | foil |
| | Foil thickness | μm | 15 | 15 | 15 | 15 |
| Positive | Total solids content | Parts by mass | 100 | 100 | 100 | 100.4 |
| electrode | Positive electrode | % by mass | 99.0% | 98.0% | 96.2% | 98.6% |
| layer | active material | | | | | |
| | (inclusive of carbon | | | | | |
| | coat) | | | | | |
| | Positive electrode | % by mass | 97.5% | 96.5% | 94.7% | 97.1% |
| | active material | | | | | |
| | (exclusive of | | | | | |
| | carbon coat) | | | | | |
| | Conducting agent | % by mass | 0.0% | 0.0% | 0.0% | 0.4% |
| | Binder | % by mass | 1.0% | 2.0% | 3.8% | 1.0% |

| Effects | Resistance | A | B | C | A |
|---|---|---|---|---|---|
| | Low temperature output | A | B | C | A |
| | Post-storage low | A | A | A | A |
| | temperature output | | | | |
| | Energy density | A | A | B | A |
| | Measurement of the size | A | A | A | B |
| | of coarse particles in the | | | | |
| | composition and | | | | |
| | electrode strength | | | | |

TABLE 2

| | | | Ex. 5 | Ex. 6 | Ex. 7 |
|---|---|---|---|---|---|
| Positive | Active material | Type | Carbon- | Carbon- | Carbon- |
| electrode | | | coated | coated | coated |
| active | | | active | active | active |
| material | | | material | material | material |
| | Active material | Parts by mass | 99 | 99 | 99 |
| | Particle diameter | μm | 1.5 | 1.5 | 1.5 |
| | Carbon content of | % by mass | 1.5 | 1.5 | 1.5 |
| | carbon-coated active | | | | |
| | material | | | | |
| Conducting agent | | Type | Carbon | — | — |
| | | | black | | |
| | | Parts by mass | 1.8 | 0 | 0 |
| Binder | Type1 | Type1 | Acrylic | Acrylic | Acrylic |
| | | | particles | particles | particles |
| | Particle diameter | nm | 300 nm | 150 nm | 500 nm |
| | Parts by mass | Parts by mass | 0.5 | 0.5 | 0.5 |
| | Type2 | Type2 | CMG | CMG | CMG |
| Positive | Carbon coat | Presence or absence | Present | Present | Present |
| electrode | Foil | Type | Aluminum | Aluminum | Aluminum |
| foil | | | foil | foil | foil |
| | Foil thickness | μm | 15 | 15 | 15 |
| Positive | Total solids content | Parts by mass | 101.8 | 100 | 100 |
| electrode | Positive electrode active | % by mass | 97.2% | 99.0% | 99.0% |
| layer | material | | | | |
| | (Inclusive of carbon | | | | |
| | coat) | | | | |
| | Positive electrode active | % by mass | 95.8% | 97.5% | 97.5% |
| | material | | | | |
| | (Exclusive of carbon | | | | |
| | coat) | | | | |
| | Conducting agent | % by mass | 1.8% | 0.0% | 0.0% |
| | Binder | % by mass | 1.0% | 1.0% | 1.0% |

| Effects | Resistance | A | B | C |
|---|---|---|---|---|
| | Low temperature output | A | B | C |
| | Post-storage low | B | A | B |
| | temperature output | | | |
| | Energy density | B | A | A |

TABLE 3

| | | | Comp. Ex. 1 | Comp. Ex. 2 |
|---|---|---|---|---|
| Positive | Active material | Type | Carbon- | Carbon- |
| electrode | | | coated | coated |
| active | | | active | active |
| material | | | material | material |
| | Active material | Parts by mass | 99 | 99 |
| | Particle diameter | μm | 1.5 | 1.5 |
| | Carbon content of | % by mass | 1.5 | 1.5 |
| | carbon-coated active | | | |
| | material | | | |
| Conducting agent | | Type | — | — |
| | | Parts by mass | 0 | 0 |
| Binder | Type1 | Type1 | PVDF | Acrylic |
| | | | | particles |
| | Particle diameter | nm | Dissoloved | 300 nm |
| | Parts by mass | Parts by mass | 1 | 0.5 |
| | Type2 | Type2 | — | CMG |
| Positive | Carbon coat | Presence or absence | Present | Absent |
| electrode foil | Foil | Type | Aluminum | Aluminum |
| | | | foil | foil |
| | Foil thickness | μm | 15 | 15 |
| Positive | Total solids content | Parts by mass | 100 | 100 |
| electrode | Positive electrode active | % by mass | 99.0% | 99.0% |
| layer | material | | | |
| | (Inclusive of carbon | | | |
| | coat) | | | |
| | Positive electrode active | % by mass | 97.5% | 97.5% |
| | material | | | |
| | (Exclusive of carbon | | | |
| | coat) | | | |
| | Conducting agent | % by mass | 0.0% | 0.0% |
| | Binder | % by mass | 1.0% | 1.0% |

| Effects | Resistance | D | D |
|---|---|---|---|
| | Low temperature output | D | D |
| | Post-storage low temperature | D | D |
| | output | | |
| | Energy density | A | A |
| | Measurement of the size of | D | A |
| | coarse particles in the | | |
| | composition and electrode | | |
| | strength | | |

From the results shown in Tables 1 and 2, it was found that Examples 1 to 7 were excellent in the resistance of the positive electrode, the low-temperature output of the non-aqueous electrolyte secondary battery, the post-storage low-temperature output of the non-aqueous electrolyte secondary battery, the energy density of the non-aqueous electrolyte secondary battery, and the coatability of the positive electrode composition.

From the results shown in Table 3, it was found that Comparative Example 1 was inferior in the resistance of the positive electrode, the low-temperature output of the non-aqueous electrolyte secondary battery, the post-storage low-temperature output of the non-aqueous electrolyte secondary battery, and the coatability of the positive electrode composition.

It was found that Comparative Example 2 was inferior in the resistance of the positive electrode, the low-temperature output of the non-aqueous electrolyte secondary battery, and the post-storage low-temperature output of the non-aqueous electrolyte secondary battery.

### EXPLANATION OF REFERENCE NUMERALS

1 Positive electrode (positive electrode for non-aqueous electrolyte secondary battery)
2 Separator
3 Negative electrode
5 Outer casing
10 Non-aqueous electrolyte secondary cell
11 Positive electrode current collector
12 Positive electrode active material layer
13 Exposed section of positive electrode current collector
14 Positive electrode current collector main body
15 Current collector coating layer
31 Negative electrode current collector
32 Negative electrode active material layer
33 Exposed section of negative electrode current collector
100 Positive electrode active material
110 Particulate binder

1. A positive electrode for a non-aqueous electrolyte secondary battery, comprising a positive electrode current collector and a positive electrode active material layer provided on the positive electrode current collector, wherein:
the positive electrode active material layer comprises positive electrode active material particles with at least part of their surfaces being coated with a conductive material;
the positive electrode current collector comprises a positive electrode current collector main body and a current collector coating layer present on a surface of the positive electrode current collector main body on a side of the positive electrode active material layer; and
the positive electrode active material layer comprises a particulate binder.

2. The positive electrode according to claim 1, wherein the positive electrode active material particles are present in an amount of 93% by mass or more, relative to a total mass of the positive electrode active material layer.

3. The positive electrode according to claim 1, wherein the particulate binder is present in an amount of 4% by mass or less, relative to a total mass of the positive electrode active material layer.

4. The positive electrode according to claim 1, wherein the positive electrode active material layer contains a conducting agent, and an amount of the conducting agent is 5% by mass or less, relative to a total mass of the positive electrode active material layer.

5. The positive electrode according to claim 1, wherein the particulate binder has an average particle diameter of 50 nm or more.

6. A nonaqueous electrolyte secondary battery comprising: the positive electrode according to claim 1; a negative electrode; and a non-aqueous electrolyte present between the positive electrode and the negative electrode.

7. The nonaqueous electrolyte secondary battery of claim 6, wherein the non-aqueous electrolyte contains a lithium imide salt represented by formula (1): 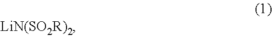
wherein R represents a fluorine atom or CₓF₍₂ₓ₊₁₎, and x is an integer from 1 to 3.

8. A battery module or battery system comprising a plurality of the non-aqueous electrolyte secondary batteries of claim 7.

9. A nonaqueous electrolyte secondary battery comprising: the positive electrode according to claim 2; a negative electrode; and a non-aqueous electrolyte present between the positive electrode and the negative electrode.

10. The nonaqueous electrolyte secondary battery of claim 9, wherein the non-aqueous electrolyte contains a lithium imide salt represented by formula (1): 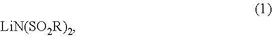
wherein R represents a fluorine atom or CₓF₍₂ₓ₊₁₎, and x is an integer from 1 to 3.

11. A battery module or battery system comprising a plurality of the non-aqueous electrolyte secondary batteries of claim 10.

12. A nonaqueous electrolyte secondary battery comprising: the positive electrode according to claim 3; a negative electrode; and a non-aqueous electrolyte present between the positive electrode and the negative electrode.

13. The nonaqueous electrolyte secondary battery of claim 12, wherein the non-aqueous electrolyte contains a lithium imide salt represented by formula (1): 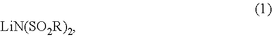
wherein R represents a fluorine atom or CₓF₍₂ₓ₊₁₎, and x is an integer from 1 to 3.

14. A battery module or battery system comprising a plurality of the non-aqueous electrolyte secondary batteries of claim 13.

15. A nonaqueous electrolyte secondary battery comprising: the positive electrode according to claim 4; a negative electrode; and a non-aqueous electrolyte present between the positive electrode and the negative electrode.

16. The nonaqueous electrolyte secondary battery of claim 15, wherein the non-aqueous electrolyte contains a lithium imide salt represented by formula (1): 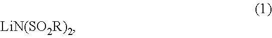
wherein R represents a fluorine atom or CₓF₍₂ₓ₊₁₎, and x is an integer from 1 to 3.

17. A battery module or battery system comprising a plurality of the non-aqueous electrolyte secondary batteries of claim 16.

18. A nonaqueous electrolyte secondary battery comprising: the positive electrode according to claim 5; a negative electrode; and a non-aqueous electrolyte present between the positive electrode and the negative electrode.

19. The nonaqueous electrolyte secondary battery of claim 18, wherein the non-aqueous electrolyte contains a lithium imide salt represented by formula (1): 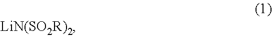
wherein R represents a fluorine atom or CₓF₍₂ₓ₊₁₎, and x is an integer from 1 to 3.

20. A battery module or battery system comprising a plurality of the non-aqueous electrolyte secondary batteries of claim 19.
